(19) United States
(12) Patent Application Publication
(10) Pub. No.: US 2012/0007500 A1
(43) Pub. Date: Jan. 12, 2012

(54) Electroluminescent Panel

(75) Inventor: Ryuichi Sato, Yokohama (JP)

(73) Assignees: TOHOKU PIONEER CORPORATION, Tendo-shi, Yamagata (JP); PIONEER CORPORATION, Kawasaki-shi, Kanagawa (JP)

(21) Appl. No.: 13/203,148

(22) PCT Filed: Feb. 25, 2009
(86) PCT No.: PCT/JP2009/053439

§ 371 Date: Sep. 26, 2011

(51) Int. Cl. H05B 33/20

(52) U.S. Cl. 313/506

(57) ABSTRACT

[Problem to be solved] An object is to provide an EL display panel which can make a non-display area on the outermost circumference of the panel area unobtrusive without causing any deterioration of the material of EL devices.

[Solving Means] The EL display panel with a plurality of electroluminescent devices is provided, on its front transparent substrate, with an optically excited layer including a photoluminescent material. The optically excited layer is disposed at a position corresponding to each electroluminescent device disposed on the outermost circumference among the electroluminescent devices.

### TECHNICAL FIELD

The present invention relates to a display panel for displaying images associated with input video signals, and more particularly, to an electroluminescent (hereinafter referred to as EL) display panel.

### BACKGROUND ART

Currently, EL display panels with the emission layer made of an organic material have been made commercially available as flat self-emission type display panels.

In recent years there is a technology suggested to arrange a plurality of such EL display panels in a matrix to construct one display panel (for example, see FIGS. 1 and 2 of Patent Literature 1).

In such a display panel, each of EL display panels (2a to 2d) is configured to have a plurality of light emitting portions (7a, 7b) each serving as a pixel and formed in between a front glass substrate (8a, 8b) and a rear glass substrate (10a, 10b). To prevent deterioration of the material of each light emitting portion caused by being exposed to outside air, each EL display panel is also provided on an end portion (90a, 90b) with a seal area in which an adhesive is filled. In this case, no light emitting portion can be formed in the seal area. Thus, in the panel area of the EL display panel, a rectangular belt-shaped non-display area that displays nothing is formed around the display area in which the light emitting portions display images. Therefore, when a display screen with a plurality of such EL display panels arranged in a matrix is viewed, a grid-shaped dark line of the non-display area is recognized at the boundary between adjacent EL display panels. Note that reducing the width of the non-display area (seal area) to make such a dark line unobtrusive possibly degrades the reliability of airtightness for the issuance portions, leading to deterioration of the material thereof.
Patent Literature 1: Japanese Patent Kokai No. 2003-098980

### DISCLOSURE OF THE INVENTION

### Problems to be Solved by the Invention

It is an object of the present invention to provide an EL display panel which can make a non-display area on the outermost circumference of the panel area unobtrusive without causing any deterioration of the material of the EL devices.

### Means for Solving the Problems

The EL display panel according to a first aspect of the present invention includes: a front transparent substrate with one surface serving as a display screen; a rear substrate; and a plurality of electroluminescent devices formed in a seal space between the front transparent substrate and the rear substrate. On the other surface of the front transparent substrate, the EL display panel is configured to have an optically excited device including a photoluminescent material formed at a position corresponding to each electroluminescent device disposed on the outermost circumference among the electroluminescent devices.

The EL display panel according to a second aspect of the present invention includes: a front transparent substrate with one surface serving as a display screen; a rear substrate; and a plurality of electroluminescent devices formed in a seal space between the front transparent substrate and the rear substrate. On the display screen of the front transparent substrate, the EL display panel is configured to have an optically excited device including a photoluminescent material formed at a position corresponding to each electroluminescent device disposed on the outermost circumference among the electroluminescent devices.

### BRIEF DESCRIPTION OF THE DRAWINGS

FIG. 1 is a schematic see-through view illustrating an EL display panel according to the present invention when viewed from above the panel.

FIG. 2 is a sectional view of the EL display panel taken along line V-V of FIG. 1.

FIG. 3 is a view illustrating an example of a sectional structure of an EL device 10.

FIG. 4 is a view illustrating the principle of extending the display area of the EL display panel shown in FIG. 1.

FIG. 5 is a sectional view illustrating an EL display panel according to another embodiment.

FIG. 6 is a sectional view illustrating an EL display panel according to still another embodiment.

FIG. 7 is a sectional view illustrating an EL display panel according to yet another embodiment.

### MODE FOR CARRYING OUT THE INVENTION

On a surface of a front transparent substrate of an EL display panel including a plurality of electroluminescent devices, an optically excited device including a photoluminescent material is provided at a position corresponding to each electroluminescent device disposed on the outermost circumference among the electroluminescent devices. This allows for extending a display area viewed in the display panel area, thereby making unobtrusive the rectangular belt-shaped non-display area, that is, the bonding layer which exists on the outer circumference portion of the display panel.

### Embodiment

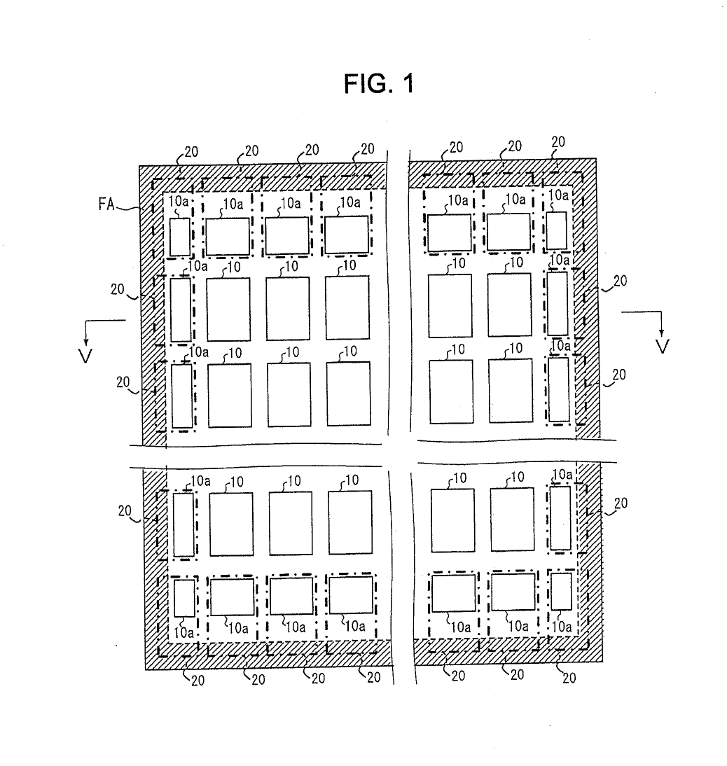

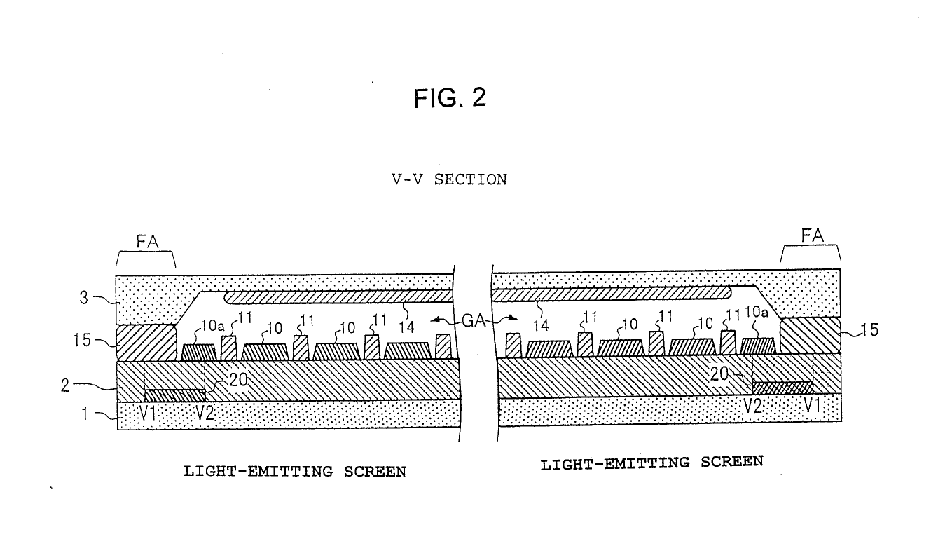

FIG. 1 is a schematic see-through view illustrating an EL display panel according to the present invention when viewed from above the panel. FIG. 2 is a sectional view of the EL display panel taken along line V-V of FIG. 1.

As shown in FIG. 2, such an EL display panel has a stacked layer structure which includes a front transparent substrate 1, a flattened layer 2, and a rear substrate 3, each of which has a two-dimensional plane with the same length-to-width size as that of the display screen of the EL display panel. One surface of the front transparent substrate 1 formed of a transparent material such as glass serves as the display screen of the EL display panel. The other surface is provided thereon with the flattened layer 2 that is formed of a transparent material such as polyimide or an inorganic material. In between the flattened layer 2 and the rear substrate 3, there is provided a sealed space GA in which EL devices 10 each serving as a pixel (a red pixel, blue pixel, or green pixel) and partition ribs 11 are formed. As shown in FIG. 1, on one surface of the flattened layer 2 (the surface that is not in contact with the front transparent substrate 1) in such an sealed space GA, the EL devices 10 (denoted with solid lines) are arranged in a matrix, each being surrounded by the partition ribs 11.

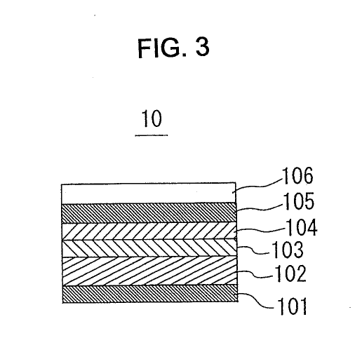

FIG. 3 is a view illustrating an example of the sectional structure of the EL device 10. The example of the EL device 10 shown below includes a transparent electrode 101 as the anode and a rear electrode 105 as the cathode. As shown in FIG. 3, the EL device 10 includes the transparent electrode 101 formed on the surface of the flattened layer 2, a hole injection layer 102, such as of copper phthalocyanine (CuPc), formed on the transparent electrode 101, and a hole transport layer 103, for example, of NPB (N,N-di(naphtalence)-N,N-dipheneyl-benzidene), deposited thereon. This hole transport layer 103 functions to transport holes injected from the transparent electrode 101 into an organic emission layer 104. This hole transport layer 103 may be formed of only one layer or two or more layers stacked on another. Furthermore, the entirety of the hole transport layer 103 may be formed not only of a single material but also a plurality of materials. Alternatively, the hole transport layer 103 may also be formed of a host material of high charge transport capability doped with a guest material of a high charge donating (accepting) property.

Then, the organic emission layer 104 is deposited on the hole transport layer 103. As an example, by resistance heating vapor deposition, the emission layers of Red (R), Green (G), and Blue (B) are deposited on the respective deposition regions using a color separation mask. Used as Red (R) is an organic material which emits red light, for example, a styryl dye such as DCM 1 (4-(dicyanomethylene)-2-methyl-6-(4′-dimethylaminostyryl)-4H-pyran). Used as Green (G) is an organic material which emits green light, such as aluminum quinolinol complex (Alq₃). Used as Blue (B) is an organic material which emits blue light, such as distyryl derivatives or triazole derivatives. Note that another material, for example, of a host-guest system layer structure may also be used, and as its light-emitting material, a fluorescent material or phosphorescent material may also be employed.

Deposited on the organic emission layer 104 is an electron transport layer 105, which is formed of various types of materials such as aluminum quinolinol complex (Alq₃) by various types of deposition methods such as by resistance heating vapor deposition. The electron transport layer 105 functions to transport electrons injected from a rear electrode 106, serving as the cathode, into the organic emission layer 104. The electron transport layer 105 may have only one layer or a multi-layer structure with two or more layers stacked on another. Furthermore, the entirety of the electron transport layer 105 may be formed of not only a single material but also a plurality of materials, or a host material of a high charge transport capability doped with a guest material of a high charge donating (accepting) property.

The rear electrode 106 is shaped, for example, in a striped pattern in a direction orthogonal to the pattern of the transparent electrode 101. The rear 106 functioning as the cathode is formed of a material of a lower work function than that of the anode in order to serve to inject electrons. For example, when the anode is formed of ITO, it is preferable to employ aluminum (Al) or a magnesium alloy (Mg—Ag). However, since Al has a low electron injection capability, it is preferable to provide an electron injection layer such as of LiF between the Al and the electron transport layer.

Note that each of the transparent electrode 101 and the rear electrode 105 is connected to a lead terminal (not shown) that is exposed to outside. The lead terminal is made of metal of a low resistance such as Al, Cr, or Ag, an alloy thereof, or a layered structure thereof.

Note that the rear substrate 3 is provided with a desiccant 14 for preventing moisture in the sealed space GA, with the desiccant 14 pasted on one surface of the rear substrate 3 in the sealed space GA. Furthermore, in between the end portion of the rear substrate 3 and the end portion of the flattened layer 2, there is formed a bonding layer 15 for bonding the portions together and sealing the sealed space GA. Such a bonding layer 15 results in a rectangular belt-shaped seal area FA, as shown by the diagonally shaded area of FIG. 1, which exists on the outer circumference of the EL display panel.

For example, the desiccant 14 may be a physical adsorption type desiccant such as zeolite, silica gel, carbon, and carbon nanotube; a chemical adsorption type desiccant such as alkali metal oxide, metal halide, and chlorine peroxide; a desiccant with an organic metal complex dissolved in a petroleum oil-based solvent such as toluene, xylene, and aliphatic organic solvent, or a desiccant with desiccant particles dispersed into a transparent binder such as polyethylene, polyisoprene, and polyvinyl cinnamate.

The adhesive 15 may be formed of thermosetting type, chemically cured type (two-part liquid mixture), or optically (ultraviolet) cured type materials, for example, acrylic resin, epoxy resin, polyester, and polyolefin. It is particularly preferable to employ an adhesive of ultraviolet cured epoxy resin which can be instantly hardened without requiring heat treatment. Note that the adhesive 15 can also be formed of glass.

Furthermore, by hermetic sealing, it may also be acceptable to form the sealed space GA which has a sealing recessed portion as mentioned above. Alternatively, the sealed space GA may contain, for example, a filler such as resin or silicone oil provided by sealing, and may be sealed by solid sealing using resin film or metal foil or by film sealing to seal the EL device 10 using barrier film.

Here, the flattened layer 2 includes a plurality of EL excited devices 20 (which are each surrounded by an alternate long and short dashed line of FIG. 1) serving as an optically excited layer. The flattened layer 2 is preferably formed of a light-transmitting and insulative material, such as polyimide, acryl, or SiO₂.

As shown in FIG. 1 or 2, on the surface (which is opposite to the display screen) of the front transparent substrate 1, each EL excited device 20 is formed at a position corresponding to that of each EL device 10a disposed on the outermost circumference among the EL devices 10, that is, nearest to the end of the EL display panel. More specifically, at a position corresponding to that of each EL device 10a, each EL excited device 20 is disposed closer to the end of the EL display panel than the EL device 10a is. At this time, as shown in FIG. 2, each EL excited device 20 has such a device width (V1 to V2) in which the seal area FA exists on the line (shown by a broken line) perpendicular to the surface of the EL excited device 20 and including its one end V1 and in which the emission plane of the EL device 10a exists on the perpendicular line (shown by a broken line) which includes the other end V2. That is, as shown in FIG. 1 or FIG. 2, the EL excited device 20 has, in its region opposite to the one surface (which is not in contact with the front transparent substrate 1), such a width that covers both part (or the whole) of the seal area FA of the bonding layer 15 and part (or the whole) of the emission plane of the aforementioned EL device 10a.

Here, in the seal area FA, the lead terminal or drive ICs for driving the EL devices to start or stop emitting light may also be formed. The present invention allows for forming a larger seal area FA, thereby providing a higher degree of flexibility in the design of the EL display panel.

The present invention is applicable to either cases where the EL devices 10 formed on the transparent substrate 1 are provided as single devices or constructed as arrayed devices. Furthermore, the drive scheme for starting and stopping emitting light from the EL device 10 may be either the passive drive scheme for the transparent electrode 101 and the rear electrode 106 formed in an X-Y matrix or the TFT active drive scheme.

The optically excited layer is formed by allowing a photoluminescent (hereinafter referred to as PL) material or a material being excited upon reception of light to be dispersed into a base material such as polymer.

The PL excited material used is an excited emission dye material which has an absorption peak in the region from 250 to 780 nm and whose emission wavelength has a peak at a longer wavelength than the excited absorption peak. Examples include band-gap engineered inorganic compounds of Y₂O₂S:Eu, Gd, ZnS:Cu, Al, BaMgAl₁₀O₁₇:Eu, or SiAlON phosphor; CdSe/ZnS nanocrystal (Quantum Dot Nanomaterials); phenyl-based compounds such as p-Terphenyl or p-Quaterphenyl; and dye (including laser dye)—based organic compounds such as Coumarin derivatives or Rhodamine derivatives. The base material such as polymer may preferably be a transparent material such as an acryl-based material, epoxy-based material, or PMMA.

The scheme for dispersing a PL excited material into a base material as described above may employ the following various types of processes:

(1) Patterning by simultaneous vapor deposition of the PL excited material and the base material;
(2) Patterning by applying, ink-jet printing, or printing of a liquid mixture containing the PL excited material and the base material; or
(3) Patterning and affixing or transferring a film with the PL excited material dispersed into the base material.

At this time, the concentration at which the PL excited material is dispersed in the base material preferably falls within the range of such a concentration that may not cause concentration quenching in the PL excited material.

That is, the optically excited layer is formed on the surface of the front transparent substrate 1 through the process mentioned above. Then, to eliminate step heights due to the optically excited layer, the flattened layer 2 is formed on the front transparent substrate 1 so as to cover the optically excited layer.

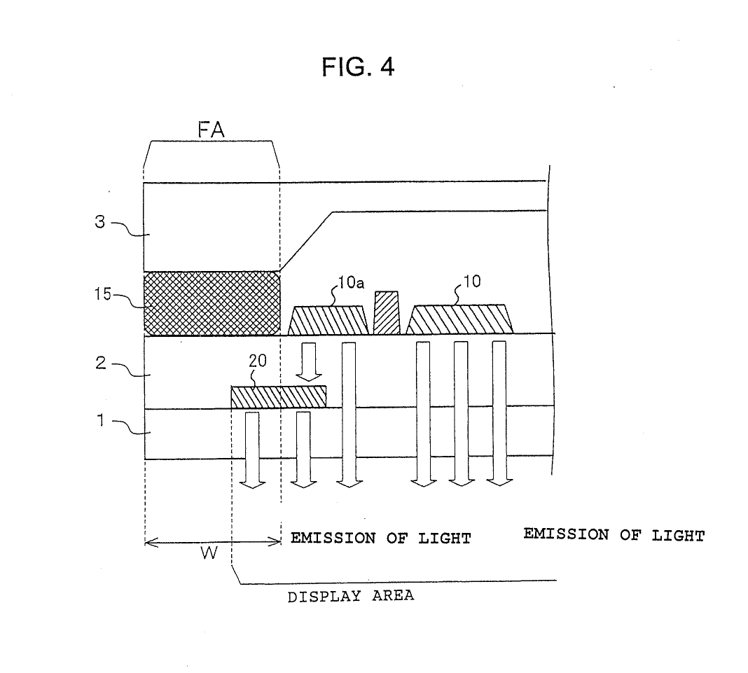

The optically excited layer is excited to emit light when having received on its surface a beam of light emitted from the EL device 10, particularly, from the EL device 10a dispose at a position closest to the end of the EL display panel. That is, first, on the surface of the optically excited layer, the PL excited particles present at the region illuminated directly with the light from the EL device 10a emit light. Then, the light emitted from the PL excited particles causes each of the PL excited particles disposed at the region having not been directly illuminated with the light emitted from the EL device 10a to be excited and emit light consecutively. As shown in FIG. 4, this allows the light emitted from the EL device 10a to extend into the seal area FA.

Accordingly, the optically excited layer makes it possible to extend the viewed display area to the endmost portion of the EL display panel irrespective of the width W of the seal area FA as shown in FIG. 4. Thus, even when the width W of the seal area FA is extended in order to improve the reliability of hermeticity of the sealed space GA in which a plurality of EL devices 10 are formed, the non-display area caused by the seal area FA can be made unobtrusive.

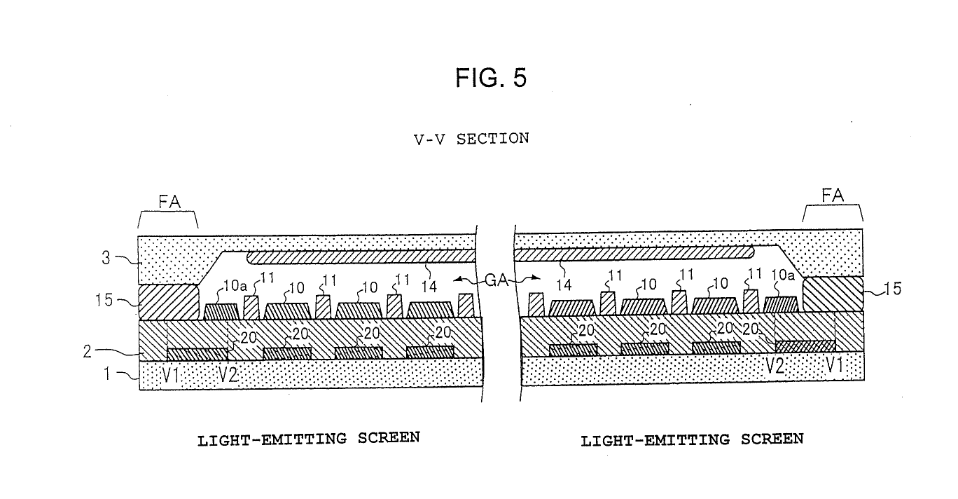

Note that in the aforementioned embodiment, a plurality of optically excited layers (EL excited devices 20) are each disposed only at a position corresponding to that of each EL device 10a which is disposed at the outermost position among the EL devices 10 arranged in a matrix as shown in FIG. 1. However, as shown in FIG. 5, the optically excited layers may also be provided each at a position corresponding to that of each of all the EL devices 10.

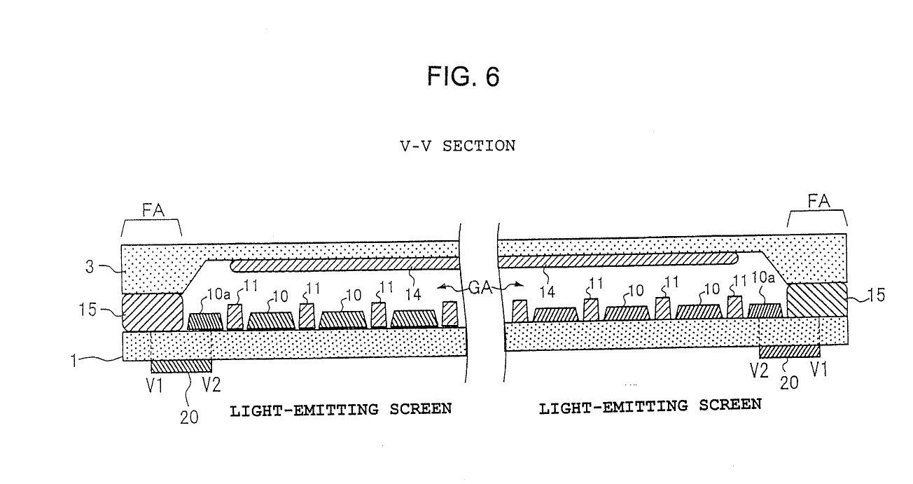

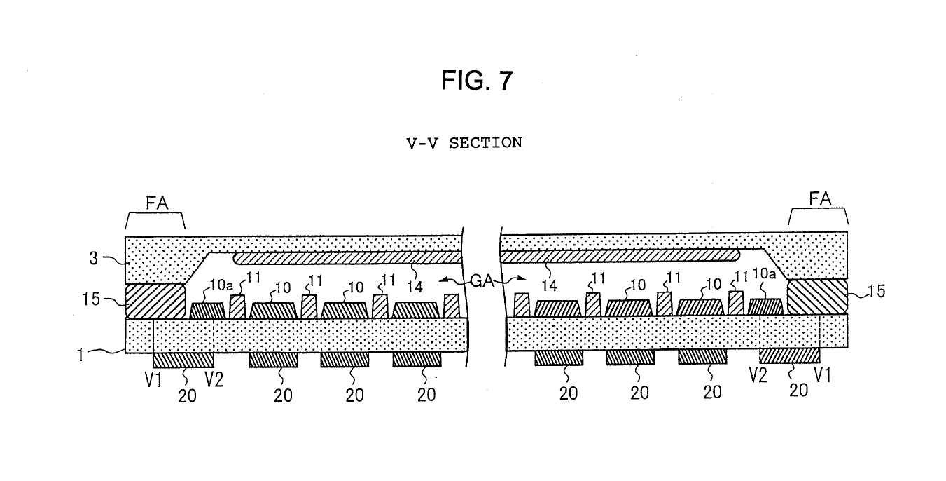

Furthermore, in the example shown in FIG. 2 or FIG. 5, a plurality of optically excited layers are formed on the surface opposite to the display screen among the two surfaces of the front transparent substrate 1. However, as shown in FIG. 6 or FIG. 7, these optically excited layers (the EL excited devices 20) may also be formed on the display screen side of the front transparent substrate 1. At this time, as shown in FIG. 6 or FIG. 7, the flattened layers 2 will be required no more, thus allowing a structure without them to be employed.

### DESCRIPTION OF REFERENCE

1 front transparent substrate
2 flattened layer
3 rear substrate
10 EL device
14 desiccant
15 bonding layer
20 EL excited device

1. An EL panel comprising: a front transparent substrate with one surface serving as a light-emitting screen; a rear substrate; and a plurality of electroluminescent devices formed in a seal space between the front transparent substrate and the rear substrate, wherein
on the other surface of the front transparent substrate, an optically excited device including a photoluminescent material is formed at a position corresponding to each electroluminescent device disposed on the outermost circumference among the electroluminescent devices.

2. The EL panel according to claim 1, wherein a flattened layer including the optically excited layer is formed on the other surface of the front transparent substrate, and
each of the electroluminescent devices is formed on the surface of the flattened layer in the seal space.

3. The EL panel according to claim 2, further comprising a bonding layer for bonding together an end portion of each of the flattened layer and the rear substrate, and wherein
the optically excited layer has such a width in which the bonding layer exists on a line perpendicular to a surface of the optically excited layer and including one end of the optically excited layer, and in which an electroluminescent device disposed on the outermost circumference exists on a line perpendicular to the surface of the optically excited layer and including the other end of the optically excited layer.

4. The EL panel according to claim 1, wherein on the other surface of the front transparent substrate in the flattened layer, an optically excited layer including a photoluminescent material is also formed at a position corresponding to each electroluminescent device disposed inside the electroluminescent devices disposed on the outermost circumference.

5. An EL panel comprising: a front transparent substrate with one surface serving as a light-emitting screen; a rear substrate; and a plurality of electroluminescent devices formed in a seal space between the front transparent substrate and the rear substrate, wherein
on the display screen of the front transparent substrate, an optically excited device including a photoluminescent material is formed at a position corresponding to each electroluminescent device disposed on the outermost circumference among the electroluminescent devices.

6. The EL panel according to claim 5, wherein each of the electroluminescent devices is formed on the other surface of the front transparent substrate.

7. The EL panel according to claim 6, further comprising a bonding layer for bonding together an end portion of each of the front transparent substrate and the rear substrate, and wherein
the optically excited layer has such a width in which the bonding layer exists on a line perpendicular to a surface of the optically excited layer and including one end of the optically excited layer, and in which an electroluminescent device disposed on the outermost circumference exists on a line perpendicular to the surface of the optically excited layer and including the other end of the optically excited layer.

8. The EL panel according to claim 5, wherein on the light-emitting screen of the front transparent substrate, an optically excited layer including a photoluminescent material is also formed at a position corresponding to each electroluminescent device disposed inside the electroluminescent devices disposed on the outermost circumference.

9. The EL panel according to claim 2, wherein on the other surface of the front transparent substrate in the flattened layer, an optically excited layer including a photoluminescent material is also formed at a position corresponding to each electroluminescent device disposed inside the electroluminescent devices disposed on the outermost circumference.

10. The EL panel according to claim 6, wherein on the light-emitting screen of the front transparent substrate, an optically excited layer including a photoluminescent material is also formed at a position corresponding to each electroluminescent device disposed inside the electroluminescent devices disposed on the outermost circumference.
